(19) United States
(12) Patent Application Publication
(10) Pub. No.: US 2026/0351006 A1
(43) Pub. Date: Nov. 5, 2026

(54) INCREMENTAL SCALE ESTIMATION FOR VISION-BASED AUTONOMOUS DRIVING SYSTEMS

(71) Applicant: GM GLOBAL TECHNOLOGY OPERATIONS LLC, Detroit, MI (US)

(72) Inventors: Dan LEVI, Ganei Tikvah (IL); Elad FARHI, Atlit (IL); Lior BARAK, Binyamina (IL); Jonathan NAOR, Atlit (IL); Alex CHERNIAKOV, Rehovot (IL)

(21) Appl. No.: 19/194,338

(22) Filed: Apr. 30, 2025

(51) Int. Cl. G06V 20/58; G06T 7/579; G06T 7/73; G06V 10/52; G06V 10/77

(52) U.S. Cl. CPC G06V 20/586; G06T 7/579; G06T 7/74; G06V 10/52; G06V 10/7715; G06T 2207/30264

(57) ABSTRACT

A vision-based perception system for a vehicle includes N cameras arranged on the vehicle and configured to generate a plurality of images. An image analysis module is configured to identify a plurality of parking slot features in the plurality of images and to generate a plurality of keyframe measurements based thereon. A keyframe selecting module is configured to identify selected ones of the plurality of keyframe measurements. A simultaneous localization and measurement (SLAM) module is configured to generate and store SLAM state values in a database and to selectively output unassociated keyframe measurements and existing features of parking slots within a predetermined range of the vehicle. A per camera scaler is configured to receive the selected ones of the keyframe measurements from the keyframe selecting module, apply a per camera scale to the selected ones of the keyframe measurements, and output scaled keyframe measurements to the database.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicles including autonomous driving systems, and more particularly to scale estimator for vision-based autonomous driving systems.

Vehicles may include autonomous driving systems that operate the vehicle without driver input. The autonomous driving systems receive images from multiple cameras pointed in different directions. For example, the vehicle may include one or more forward facing cameras, one or more side facing cameras, and one or more rear facing cameras. Autonomous driving systems need to be able to identify objects in the images and the location of the objects in the images relative to the vehicle that is moving.

### SUMMARY

A vision-based perception system for a vehicle includes N cameras arranged on the vehicle and configured to generate a plurality of images, where N is an integer greater than one. An image analysis module is configured to identify a plurality of parking slot features in the plurality of images and to generate a plurality of keyframe measurements based thereon. A keyframe selecting module is configured to identify selected ones of the plurality of keyframe measurements. A simultaneous localization and measurement (SLAM) module is configured to generate and store SLAM state values in a database and to selectively output unassociated keyframe measurements and existing features of parking slots within a predetermined range of the vehicle. A per camera scaler is configured to receive the selected ones of the keyframe measurements from the keyframe selecting module, apply a per camera scale to the selected ones of the keyframe measurements, and output scaled keyframe measurements to the database.

In other features, a data association module is configured to receive unassociated measurements and existing states within a predetermined distance from the vehicle from the database. The data association module is configured to selectively associate selected ones of the keyframe measurements to existing states and other selected ones of the keyframe measurements to new states.

In other features, a scale estimating module includes a per measurement scale calculator configured to calculate a per measurement scale for the keyframe measurements for existing states and the keyframe measurements for new states. The keyframe measurements for at least one of the existing states and the new states include n rays each having a start location at a corresponding one of the N cameras, an end location at a corresponding one of the parking slot features, and a first distance between the start location and the end location, where n is an integer greater than two.

In other features, the per measurement scale calculator is configured to calculate an estimated location L of the one of the parking slot features by averaging the end location of the n rays. The per measurement scale calculator is configured to determine n middle locations on the n rays closest to an estimated location L of the one of the parking slot features using a least means squared function.

In other features, the per measurement scale calculator is configured to calculate the scale per measurement for the n rays based on a ratio of a first distance from the start location of each of the n rays to a corresponding one of the n middle locations divided by a second distance from the start location of each of the n rays to the end location of each of the n rays. The scale estimating module is configured to calculate a confidence level for each of the n rays. The scale estimating module includes a per camera scale calculator configured to update the scale per camera in response to the scale per measurement for the n rays.

In other features, a scale database is configured to store the scale per measurement for the n rays and the scale per camera updated by the scale per measurement for the n rays.

A vision-based perception system for a vehicle includes an image analysis module configured to identify a plurality of parking slot features in a plurality of images and to generate a plurality of keyframe measurements based thereon. A keyframe selecting module is configured to identify selected ones of the plurality of keyframe measurements. A simultaneous localization and measurement (SLAM) module is configured to generate and store SLAM state values in a database and to selectively output unassociated keyframe measurements and existing parking slot features within a predetermined range of the vehicle. A per camera scaler is configured to receive the selected ones of the keyframe measurements from the keyframe selecting module, apply a per camera scale to the selected ones of the keyframe measurements, and output scaled keyframe measurements to the database. A data association module is configured to receive unassociated measurements and existing states within a predetermined distance from the vehicle from the database. The data association module is configured to selectively associate selected ones of the keyframe measurements to existing states and associate other ones of the keyframe measurements to new states. A scale estimating module includes a per measurement scale calculator configured to calculate a per measurement scale for the keyframe measurements for existing states and the keyframe measurements for new states.

In other features, the keyframe measurements for at least one of the existing states and the new states include n rays each having a start location at a corresponding one of N cameras of the vehicle, where N is an integer greater than one, an end location at a corresponding one of the parking slot features, and a first distance between the start location and the end location, where n is an integer greater than two. The per measurement scale calculator is configured to calculate an estimated location L of the one of the parking slot features by averaging the end location of the n rays. The per measurement scale calculator is configured to determine n middle locations on the n rays closest to an estimated location L of the one of the parking slot features using a least means squared function. The per measurement scale calculator is configured to calculate the scale per measurement for the n rays based on a ratio of a first distance from the start location of each of the n rays to a corresponding one of the n middle locations divided by a second distance from the start location of each of the n rays to the end location of each of the n rays.

In other features, the scale estimating module is configured to calculate a confidence level for each of the n rays. The scale estimating module includes a per camera scale calculator configured to update the scale per camera in response to the scale per measurement for the n rays.

In other features, a scale database is configured to store the scale per measurement for the n rays and the scale per camera updated by the scale per measurement for the n rays.

A scale estimating module for a vision-based perception system for a vehicle includes a per measurement scale calculator configured to calculate a per measurement scale for keyframe measurements. The keyframe measurements include n rays each having a start location at one of N cameras arranged on the vehicle, where N is an integer greater than one, an end location at a parking slot feature of a parking slot, and a first distance between the start location and the end location, where n is an integer greater than two. The per measurement scale calculator is configured to calculate an estimated location L of the parking slot feature by averaging the end locations of the n rays; determine n middle locations on the n rays closest to an estimated location L of the parking slot feature using a least means squared function; and calculate the scale per measurement for the n rays based on a ratio of a first distance from the start location of each of the n rays to a corresponding one of the n middle locations divided by a second distance from the start location of each of the n rays to the end location of each of the n rays.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example of a vehicle including a vision-based perception system according to the present disclosure;

FIG. 2A is a plan view of an example of a vehicle passing through a parking lot with parking slots and parking in one of the parking slots according to the present disclosure;

FIG. 2B illustrates an example of a vehicle in a parking slot according to the present disclosure;

FIG. 3 is flowchart of an example of a method for performing vision-based object detection without scale estimation;

FIG. 4 is a flowchart of an example of a method for performing vision-based object detection with scale estimation according to the present disclosure;

FIG. 5 illustrates an example of rays representing the same landmark according to the present disclosure;

FIG. 6 is a flowchart of an example of a scale estimation system according to the present disclosure.

In the drawings, reference numbers may be reused to identify similar and/or identical elements.

### DETAILED DESCRIPTION

While a scale estimation system for vision-based perception systems is illustrated below in the context of autonomous vehicles, scale estimation can be used in other types of vision-based systems.

Vehicles may include an autonomous driving system that operates the vehicle without driver input. The autonomous driving system receives images from multiple cameras that are pointed in two or more different directions. For example, the vehicle may include one or more forward facing cameras, one or more side facing cameras, and one or more rear facing cameras. Autonomous driving systems that are vision-based identify objects in the images and the relative location of the objects in the images.

Current vision-based systems assume a fixed scale for each camera or scenario. Using a fixed scale causes inaccuracies and poor adaptability in dynamic environments. Scale is not directly observable for monocular SLAM. Therefore, the scale is estimated which leads to potential inconsistencies and ambiguity. Using an incorrect scale distorts trajectories, maps, and/or localization. Using fixed scale assumptions limit performance in dynamic environments. Scale errors may also degrade simultaneous localization and mapping (SLAM) reliability and loop closures (e.g., recognizing a previously-visited location and updating beliefs accordingly).

The vision-based system according to the present disclosure dynamically estimates the scale for keyframe measurement. More particularly, the scale estimator performs online incremental per-measurement scale estimation for vision-based simultaneous localization and mapping (VSLAM) systems. The scale estimator addresses scale ambiguity without fixed assumptions per camera or keyframe measurement basis.

Using factor graph-based MAP estimation, the scale estimator dynamically optimizes the estimated scale per measurement, which ensures adaptability and robustness. The scale estimator is decoupled from SLAM state estimation to enhance stability while a per-camera initializer improves convergence and data association. In some examples, the SLAM states correspond to vehicle and/or camera locations and a parking slot features such as corners or centers of parking slots. The scale estimator supports multiple cameras and sensor setups. In some examples, the scale estimator uses one or more scale uncertainty estimation methods (to generate a confidence level) and achieves real-time performance.

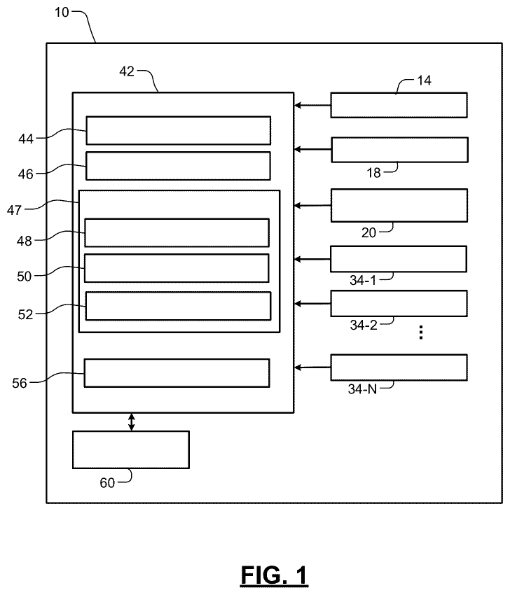

Referring now to FIG. 1, a vehicle 10 includes various sensors such as a global positioning system (GPS) 14, an inertial measurement unit (IMU) 18, and wheel speed sensors 20. The vehicle 10 includes one or more cameras 34-1, 34-2, . . . , and 34-N that generate images in forward, side, and/or rear directions relative to the vehicle 10, wherein N is an integer greater than one. In some examples, the cameras 34-1, 34-2, . . . , and 34-N include one or more forward-facing cameras, one or more side-facing cameras, and one or more rear-facing cameras.

A controller 42 includes an image analysis module 44 configured to receive the images from the cameras 34-1, 34-2, . . . , and 34-N, identify landmarks (e.g., corners parking slots) in the images, and generate measurements from the corresponding camera to the landmarks in the images. In some examples, the image analysis module 44 may include a neural network configured to identify various objects such as corners of parking slots.

A keyframe selecting module 46 selects keyframes (each with a timestamp) from the images. The cameras 34-1, 34-2, . . . , and 34-N generate a lot of samples and not all of the samples provide new or useful information. For example, the measurements may or may not change significantly in subsequent keyframes during sequential timestamps when the vehicle is stationary or travelling slowly. Not all of the images include parking slots. The keyframe selecting module 46 is configured to select some or all of the keyframes depending upon the value of the data.

A simultaneous localization and mapping (SLAM) module 47 is configured to perform simultaneous localization and mapping. In some examples, the SLAM module 47 includes Georgia Tech smoothing and mapping (GTSAM) or g2o modules, although other SLAM modules can be used.

In some examples, an optimization module 52 is configured to manage and optimize SLAM states (e.g., vehicle locations and locations of parking slot features). In some examples, the SLAM states correspond to vehicle and/or camera locations and parking slot features such as corners or centers of parking slots. In some examples, the optimization module 52 includes a cost function that is extended with parking slot/lot specific factors. Examples of parking slot/lot factors include most parking slots are quadrilateral, opposite sides of the parking slot are typically equal in length, opposite sides are generally parallel, most are generally rectangular, neighboring slots generally have similar dimensions, neighboring slots are generally co-parallel, etc. Additional details relating to extension of the optimization module 52 with parking slot factors can be found in commonly-assigned U.S. patent application Ser. No. xx/xxx,xxx (Attorney Docket No. P110856), entitled “Optimization System for Mapping Parking Slots Using Simultaneous Localization and Mapping”, which is hereby incorporated by reference in its entirety.

The controller 42 further includes a scale estimating module 56 configured to estimate a scale of measurements on a per camera and/or per measurement basis as will be described further below.

The controller 42 includes an autonomous driving module 58 configured to control actuators 60 to adjust steering, braking, and/or acceleration of the vehicle 10. For example, the autonomous driving module 58 may park the vehicle in one of the parking slots identified and mapped by the SLAM module 47.

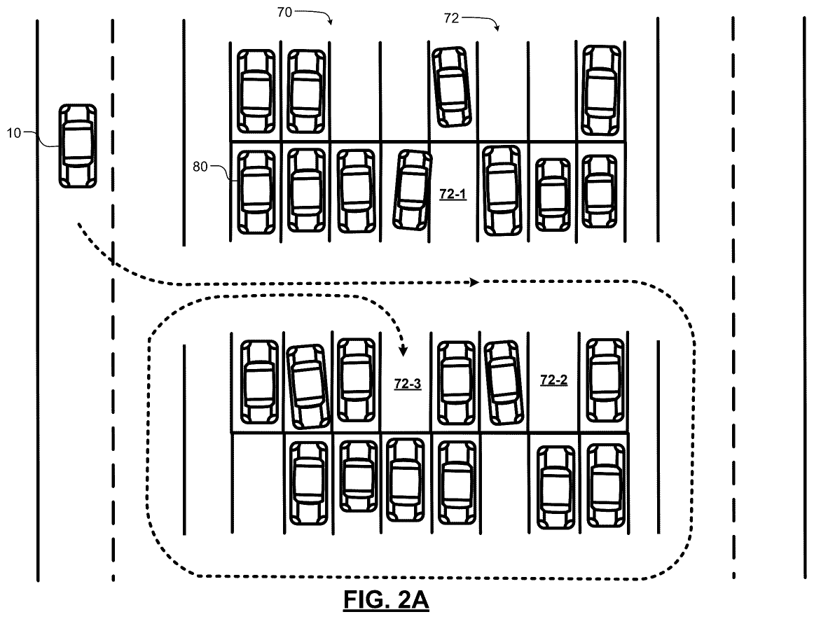

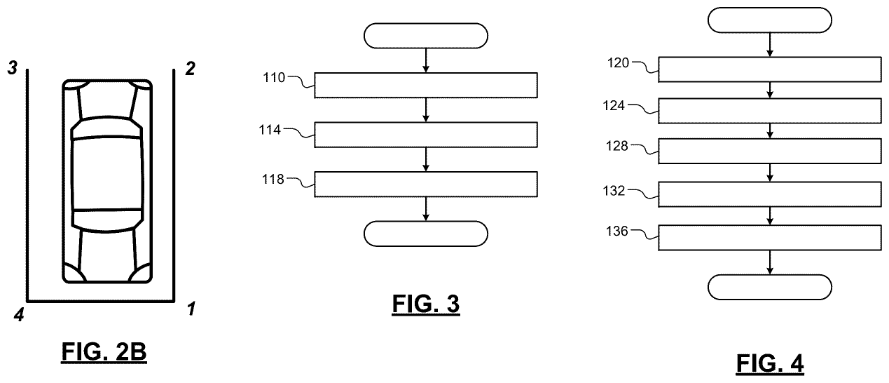

Referring now to FIG. 2A, the vehicle 10 enters a parking lot 70 including plurality of parking slots 72. The vehicle 10 generates images using the cameras 34-1, 34-2, . . . , and 34-N. Some of the images are selected as keyframes. Some of the selected keyframes may include parking slots that are identified by center and/or corner locations. The keyframes include locations of some or all of the corners of one or more parking slots at a given timestamp. In some examples, the keyframes are generated by one camera (such as parking slots located on one side of the vehicle 10). In some examples, the keyframes for a given timestamp can be generated by cameras on both sides of the vehicle, the front camera, and/or the rear camera.

Some of the parking slots 72 are occupied by vehicles 80 and others of the parking slots 72 are open. The vehicle 10 may proceed directly to one of the parking slots 72 such as parking slot 72-1 or parking slot 72-2 or the vehicle 10 may drive around the parking lot 70 before selecting one of the parking slots such as parking slot 72-3.

Referring now to FIG. 2B, an example of a parking slot including corners 1, 2, 3, and 4 is shown. In some examples, the locations of the corners 2, 3 may be detected (with high confidence and low covariance) and the corners 1, 4 may be estimated (with lower confidence and higher covariance) due to the position of the vehicle being closer to corners 2, 3.

Referring now to FIG. 3, a prior method for identifying parking slots without scale estimation includes receiving new measurements at 110. At 114, the method performs data association. At 118, the method performs optimization.

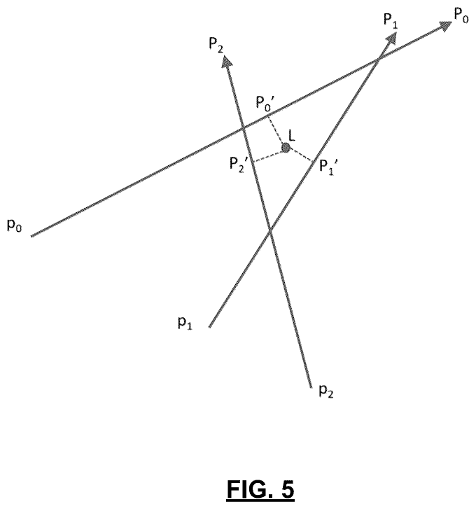

In FIG. 4, a method for identifying parking slots including scale estimation according to the present disclosure is shown, The method includes receiving new measurements at 120. In some examples, the new measurements or keyframes include landmarks such as centers or corners of a parking slots. At 124, a per camera scale is applied. At 128, the method includes performing data association. At 132, per measurement scale is applied. At 136, the method includes performing optimization using the SLAM module.

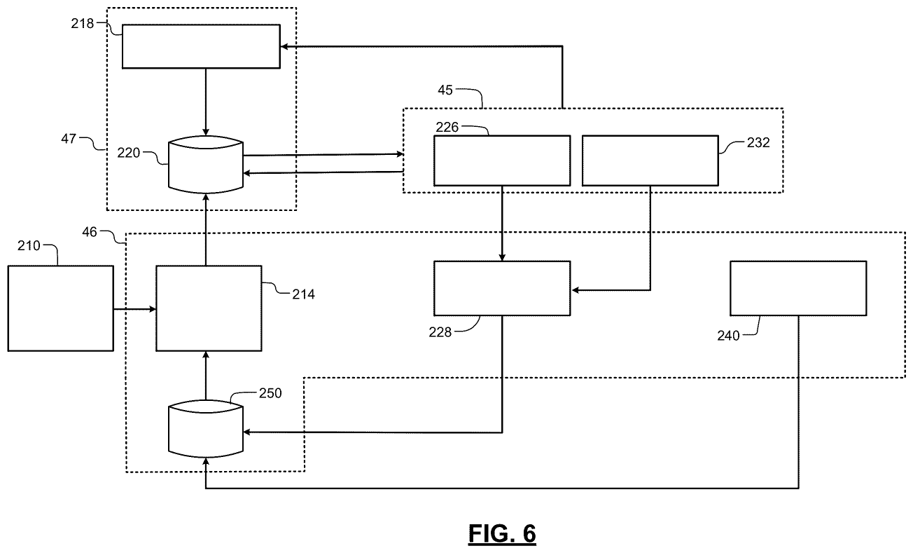

Referring now to FIG. 5, incoming measurements correspond to rays extending from pᵢ to Pᵢ (where i is in a range from 0 to n and n≥2). The rays may have an incorrect scale. In some examples, pᵢ of the ray corresponds to a location of the camera taking the image. In some examples, Pᵢ of the ray corresponds to the location of landmark L with the possibly incorrect scale. The scale estimation system transforms the rays into vectors (rays with a corrected scale). In some examples, the rays are generated by the same camera at different times (a-synchronous) or different cameras at the same or different times.

After association, three or more rays (e.g., rays p₀ to P₀, pᵢ to Pᵢ, and p₂ to P₂) form a set representing the same landmark L. In some examples, an initial guess is made regarding the location of the landmark L. For example, the initial guess may include averaging the locations P₀, P₁, and P₂ of the rays (with the incorrect scale or with a per camera scale applied), although other methods can be used. Then, the scale appropriate to each measurement is estimated using triangulation. For example, a least means squared function can be used to identify a closest point P₀′, P₁′, and P₂′ on the rays (p₀ to P₀, p₁ to P₁, and p₂ to P₂) to the landmark L. The scale is then calculated by calculating ratios P₀′/P₀, P₁′/P₁, and P₂′/P₂. Scale estimation is decoupled from SLAM state estimation to better control system robustness.

For example, the least means squared function corresponds to

$${\sum }_{i [ 0 , n )} {‖ L - {P}_{i}^{′} ‖}_{{\sum }_{{P}_{i}}}^{2} = 0$$

where L is the location of the landmark which is a-priori unknown, Pᵢ′ is the closest point to L in the i^{th} line, and n is the number of measurements (e.g., greater than or equal to three to perform triangulation). The scale measurements may also include a covariance matrix Σ_{P}_{ᵢ} that can be used to weight the estimated scale.

In some examples, one or more additional calculations may be made to generate a confidence level using a gaussian noise assumption. Examples of the additional calculations include Var(S) which is the estimated scale variance (e.g., a lower bound (on the left) and an upper bound (on the right) with Cauchy-Schwartz inequality):

$$( {σ}_{\overline{P}}^{2} - {μ}_{\overline{P}}^{2} ) \cdot ( {σ}_{L}^{2} - {μ}_{L}^{2} ) - {μ}_{\overline{P}}^{2} \cdot {μ}_{L}^{2} \leq Var ( \overline{P} ) \cdot Var ( L )$$

where Var(P̅) is the variance of the measurements, Var(L) is the variance of the landmark, σ_{P̅} is the standard deviation of the measurements, μ_{P̅} is the average of the measurements, σ_{L} is the standard deviation of the landmark location, and μ_{L} is the average of the landmark location.

Referring now to FIG. 6, new keyframe measurements are output at 210 to a per camera scaler 214 of the scale estimating module 50. The per camera scaler 214 scales the new measurements using a per camera estimated scale value at 214 and the per camera scaled measurements are stored in a database 218 associated with the SLAM module 47.

Unassociated keyframe measurements (unassociated with a parking slot) and existing states (e.g., known parking slots) are output to the data association module 45. The data association module 45 associates the measurements to the existing states at 226 and associates the measurements to new states at 232. An example of data association can be found in commonly-assigned U.S. patent application Ser. No. 19/194,253 (Attorney Docket No. P110843), entitled “A-Synchronous Association for Parking Slot Measurements”.

Outputs of the data association module 45 corresponding to new keyframe measurements for existing states or new keyframe measurements for new states are output to a scale per measurement calculator 228. The scale per measurement calculator 228 calculates an estimated scale per measurement (as described above in FIGS. 4 and 5) and stores the estimated scale per measurement value in a scale database 250 with the corresponding measurement and/or state. In some examples, a scale per camera calculator 240 updates the estimated scale per camera based on the recent estimated scales per measurement.

In one example, unscaled, raw measurements were about 20% larger than ground truth. After scaling, the scale error was about 1%. In one example involving location of parking slots, the raw measurements were in a range from 0.31 meters (m) to 0.46 m. The error after scale per camera was in a range from 0.14 m to 0.23 m. The error after scale per measurement was in a range from 0.1 m to 021 m. As can be appreciated, the scale per measurement shows an improvement in accuracy in a range from 20 to 50% as compared to non-scaled solutions.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A vision-based perception system for a vehicle, comprising:
N cameras arranged on the vehicle and configured to generate a plurality of images, where N is an integer greater than one;
an image analysis module configured to identify a plurality of parking slot features in the plurality of images and to generate a plurality of keyframe measurements based thereon;
a keyframe selecting module configured to identify selected ones of the plurality of keyframe measurements;
a simultaneous localization and measurement (SLAM) module configured to generate and store SLAM state values in a database and to selectively output unassociated keyframe measurements and existing features of parking slots within a predetermined range of the vehicle; and
a per camera scaler configured to receive the selected ones of the keyframe measurements from the keyframe selecting module, apply a per camera scale to the selected ones of the keyframe measurements, and output scaled keyframe measurements to the database.

2. The vision-based perception system of claim 1, further comprising a data association module configured to receive unassociated measurements and existing states within a predetermined distance from the vehicle from the database.

3. The vision-based perception system of claim 2, wherein the data association module is configured to selectively associate selected ones of the keyframe measurements to existing states and other selected ones of the keyframe measurements to new states.

4. The vision-based perception system of claim 3, further comprising a scale estimating module including a per measurement scale calculator configured to calculate a per measurement scale for the keyframe measurements for existing states and the keyframe measurements for new states.

5. The vision-based perception system of claim 4, wherein the keyframe measurements for at least one of the existing states and the new states include n rays each having a start location at a corresponding one of the N cameras, an end location at a corresponding one of the parking slot features, and a first distance between the start location and the end location, where n is an integer greater than two.

6. The vision-based perception system of claim 5, wherein the per measurement scale calculator is configured to calculate an estimated location L of the one of the parking slot features by averaging the end location of the n rays.

7. The vision-based perception system of claim 6, wherein the per measurement scale calculator is configured to determine n middle locations on the n rays closest to an estimated location L of the one of the parking slot features using a least means squared function.

8. The vision-based perception system of claim 7, wherein the per measurement scale calculator is configured to calculate the scale per measurement for the n rays based on a ratio of a first distance from the start location of each of the n rays to a corresponding one of the n middle locations divided by a second distance from the start location of each of the n rays to the end location of each of the n rays.

9. The vision-based perception system of claim 8, wherein the scale estimating module is configured to calculate a confidence level for each of the n rays.

10. The vision-based perception system of claim 9, wherein the scale estimating module includes a per camera scale calculator configured to update the scale per camera in response to the scale per measurement for the n rays.

11. The vision-based perception system of claim 10, further comprising a scale database configured to store the scale per measurement for the n rays and the scale per camera updated by the scale per measurement for the n rays.

12. A vision-based perception system for a vehicle, comprising:
an image analysis module configured to identify a plurality of parking slot features in a plurality of images and to generate a plurality of keyframe measurements based thereon;
a keyframe selecting module configured to identify selected ones of the plurality of keyframe measurements;
a simultaneous localization and measurement (SLAM) module configured to generate and store SLAM state values in a database and to selectively output unassociated keyframe measurements and existing parking slot features within a predetermined range of the vehicle;
a per camera scaler configured to receive the selected ones of the keyframe measurements from the keyframe selecting module, to apply a per camera scale to the selected ones of the keyframe measurements, and to output scaled keyframe measurements to the database;
a data association module configured to receive unassociated measurements and existing states within a predetermined distance from the vehicle from the database, wherein the data association module is configured to selectively associate selected ones of the keyframe measurements to existing states and associate other ones of the keyframe measurements to new states; and
a scale estimating module including a per measurement scale calculator configured to calculate a per measurement scale for the keyframe measurements for existing states and the keyframe measurements for new states.

13. The vision-based perception system of claim 12, wherein the keyframe measurements for at least one of the existing states and the new states include n rays each having a start location at a corresponding one of N cameras of the vehicle, where N is an integer greater than one, an end location at a corresponding one of the parking slot features, and a first distance between the start location and the end location, where n is an integer greater than two.

14. The vision-based perception system of claim 13, wherein the per measurement scale calculator is configured to calculate an estimated location L of the one of the parking slot features by averaging the end location of the n rays.

15. The vision-based perception system of claim 14, wherein the per measurement scale calculator is configured to determine n middle locations on the n rays closest to an estimated location L of the one of the parking slot features using a least means squared function.

16. The vision-based perception system of claim 15, wherein the per measurement scale calculator is configured to calculate the scale per measurement for the n rays based on a ratio of a first distance from the start location of each of the n rays to a corresponding one of the n middle locations divided by a second distance from the start location of each of the n rays to the end location of each of the n rays.

17. The vision-based perception system of claim 16, wherein the scale estimating module is configured to calculate a confidence level for each of the n rays.

18. The vision-based perception system of claim 17, wherein the scale estimating module includes a per camera scale calculator configured to update the scale per camera in response to the scale per measurement for the n rays.

19. The vision-based perception system of claim 18, further comprising a scale database configured to store the scale per measurement for the n rays and the scale per camera updated by the scale per measurement for the n rays.

20. A scale estimating module for a vision-based perception system for a vehicle, comprising:
a per measurement scale calculator configured to calculate a per measurement scale for keyframe measurements,
wherein the keyframe measurements include n rays each having a start location at one of N cameras arranged on the vehicle, where N is an integer greater than one, an end location at a parking slot feature of a parking slot, and a first distance between the start location and the end location, where n is an integer greater than two, and
wherein the per measurement scale calculator is configured to:
calculate an estimated location L of the parking slot feature by averaging the end locations of the n rays;
determine n middle locations on the n rays closest to an estimated location L of the parking slot feature using a least means squared function; and
calculate the scale per measurement for the n rays based on a ratio of a first distance from the start location of each of the n rays to a corresponding one of the n middle locations divided by a second distance from the start location of each of the n rays to the end location of each of the n rays.
